(19) United States
(12) Patent Application Publication
(10) Pub. No.: US 2011/0270836 A1
(43) Pub. Date: Nov. 3, 2011

(54) METHOD AND APPARATUS FOR PROVIDING AN ACTIONABLE ELECTRONIC JOURNAL

(75) Inventors: Guang Yang, San Jose, CA (US); Peter Pal Boda, Palo Alto, CA (US)

(73) Assignee: Nokia Corporation, Espoo (FI)

(21) Appl. No.: 12/771,841

(22) Filed: Apr. 30, 2010

(51) Int. Cl. G06F 17/30

(52) U.S. Cl. 707/737; 707/E17.089

(57) ABSTRACT

An approach is provided for creating an actionable electronic journal. The journal creator classifies context data associated with a user according to a plurality of dimensions, granularities, or a combination thereof. Next, the journal creator recognizes one or more events in the context data based, at least in part, on the classification. Then, the journal creator creates one or more hierarchies of the recognized events based, at least in part, on the dimensions and the granularities, and presents, communicates or publishes them in a visually friendly format, along with additional information such as metadata and advertisements, and further details associated with each events of the journal.

### BACKGROUND

Service providers, software designers and device manufacturers (e.g., wireless, cellular, etc.) are continually challenged to deliver value and convenience to consumers by, for example, providing compelling network services. One area of interest has been the development of diaries or journals for documenting routine as well as extraordinary life events. It is noted, however, that traditional methods for maintaining such diaries or journals (even electronic diaries and journals) often requires extensive user interaction such as manual input of journal entries and related content (e.g., images, files, etc.). Moreover, as the information revolution accelerates, the volume of data and/or information generated, consumed, accessed, or otherwise associated with a typical consumer is ever expanding, thereby making the task of chronicling daily activities or events even more challenging. Accordingly, service providers such as social network providers, software designers and device manufacturers as well as entertainment companies face significant technical challenges to enabling efficient compilation of information into diaries or journals while reducing or eliminating the corresponding burdens on the user.

### SOME EXAMPLE EMBODIMENTS

Therefore, there is a need for an approach for automatically and efficiently providing an actionable electronic journal. There is also a need for an apparatus that can visually render and present the created electronic journal.

According to one embodiment, a method comprises classifying context data associated with a user according to a plurality of dimensions, granularities, or a combination thereof. The method also comprises recognizing one or more events in the context data based, at least in part, on the classification. The method further comprises creating one or more hierarchies of the recognized events based, at least in part, on the dimensions and the granularities.

According to another embodiment, an apparatus comprising at least one processor, and at least one memory including computer program code, the at least one memory and the computer program code configured to, with the at least one processor, cause, at least in part, the apparatus to classify context data associated with a user according to a plurality of dimensions, granularities, or a combination thereof. The apparatus is also caused to recognize one or more events in the context data based, at least in part, on the classification. The apparatus is further caused to create one or more hierarchies of the recognized events based, at least in part, on the dimensions and the granularities.

According to another embodiment, a computer-readable storage medium carrying one or more sequences of one or more instructions which, when executed by one or more processors, cause, at least in part, an apparatus to classify context data associated with a user according to a plurality of dimensions, granularities, or a combination thereof. The apparatus is also caused to recognize one or more events in the context data based, at least in part, on the classification. The apparatus is further caused to create one or more hierarchies of the recognized events based, at least in part, on the dimensions and the granularities.

According to another embodiment, an apparatus comprises means for classifying context data associated with a user according to a plurality of dimensions, granularities, or a combination thereof. The apparatus also comprises means for recognizing one or more events in the context data based, at least in part, on the classification. The apparatus further comprises means for creating one or more hierarchies of the recognized events based, at least in part, on the dimensions and the granularities.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing an actionable electronic journal, according to one embodiment;

FIG. 2 is a diagram of the components of the journal creator, according to one embodiment;

FIG. 3 is a flowchart of a process for providing an actionable electronic journal, according to one embodiment;

FIG. 4 is a flowchart of a process for presenting events on a journal entry, according to one embodiment;

FIGS. 5A-5C are example diagrams of hierarchies utilized in the processes of FIG. 3, according to one embodiment;

FIGS. 6A-6C are example diagrams of content objects for a journal entry utilized in the processes of FIG. 3, according to one embodiment;

FIG. 7 is an example journal entry created by the processes of FIG. 3, according to one embodiment;

FIGS. 8A-8C are diagrams of the journal entry utilized in the processes of FIG. 3, according to one embodiment;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for creating, distributing and consuming an electronic journal are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

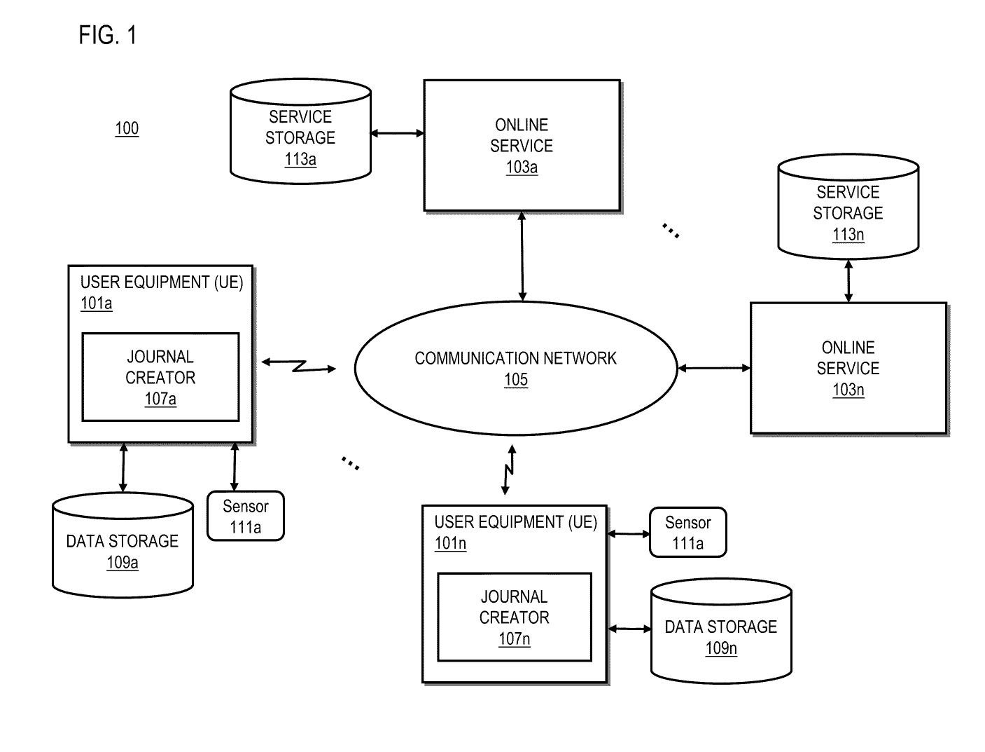

FIG. 1 is a diagram of a system capable of providing an actionable electronic journal, according to one embodiment. It is noted that users often express an interest in maintaining a diary or journal as a way of preserving memories or sharing experiences. However, this interest often quickly fades when the user is faced with the burden of creating and maintaining a journal or a blog on a routine basis. For example, the traditional way to create a diary or journal was to manually write entries or records down on paper. Modern technology has ostensibly improved the process by enabling the user to create diaries or journals using a software application instead of pen and paper. In many cases, these electronic diary/journal programs may enable a user to create diaries with different designs and features, and may enable easy importation of media (e.g., pictures, sound, videos, etc.) into the diaries. Further, the electronic diaries/journals may be easily shared with other users, via e-mail or the Internet. For example, a user may send an electronic journal entry to the user's parents as an attachment to an e-mail. As another example, the user may keep the user's journal in a form of a blog so that the user's journal entries may be shared with others via the Internet.

Although the electronic diary/journal applications may make it easy for the user to create a journal entry, the process ultimately remains manually intensive. In other words, the user still needs to create the content of the journal entries manually, by writing a journal or including media or links to web pages, for example. The creation of the journal entries may be a time-consuming process, especially for a user with a busy schedule, and thus many people may be deterred from maintaining journal entries. Further, it may be difficult for the user to keep track of all events, perceptions, stories, etc. of the past and remember to keep a record of them, and collect and organize them, since there is much that a user may see, hear and do every day. Moreover, the text entry, which is a conventional method to convey stories or information, may be a laborious process that requires a writer to think about a good way to capture the information in writing, and may not always convey information quickly, especially to readers who do not like spending time reading.

Accordingly, an automated process to create entries including information about the past is desired. It is noted that some conventional methods may automatically collect information or keep a record of past activities, for example, by keeping a log of the past communications (e.g., telephone calls and text messages) and past location visited (e.g., via the GPS device). However, these conventional methods are generally limited in scope (e.g., limited to providing a communication history or GPS tracking information). Further, in order to create a journal entry that can convey stories or information, the collected information may need to be organized into a coherent compilation of information. The compilation of the information also needs to be displayed (e.g., via visual rendering) in a way to effectively convey such information to a viewer. Furthermore, the visual rendering may provide means that enables the reader/viewer to further examine or view the information from different aspects such as topography, time, etc. and/or depth (i.e., going into further and deeper details).

To address this problem, a system 100 of FIG. 1 introduces the capability to recognize events from collected contextual data, to organize the events based on predetermined dimensions (e.g., people, activity, time, location, etc.) and/or user-defined dimensions, to create various hierarchies of the events within these dimensions at different levels of detail or granularity, to link media objects to corresponding events, and to create journal entries showing events and media objects related to the events. In one embodiment, these individual journal entries may be further compiled into a complete journal. More specifically, system 100 enables the UE 101 to collect contextual data including sensor data from the sensor 111, data on online activities and context services that may be retrieved from the online services 103a-103n and etc. The contextual data may also be formed using information from external sensors and other mobile devices as well as data for a given location available either locally or via the internet. Then, the UE 101 applies classifiers to the contextual data to classify and recognize events according to various dimensions and granularities. It can be also implemented so that all or part of the event classification happens on the network side (e.g., via the online service 103), not only on the User Equipment side. As noted, the dimensions may include categories such as When (e.g., time), Where (e.g., location), Who (e.g., people associated with the event or activity), and What (e.g., the activity or event itself). These dimensions may be predetermined standard dimensions and/or user-defined dimensions that are customized or selected by the user. In some embodiments, the dimensions may also include How (e.g., mode for performing the event or activity) and Why (e.g., motivation for the event or activity). Different granularities can then be applied to define different levels of details of the event. For example, with respect to the time dimension, different granularities may specify time according to the minute, hour, day, season, etc. Similarly, different location granularities may specify a particular point of interest, a neighborhood, a city, a state, a country, etc. In this way, hierarchies of the events may be created based on the dimensions and the granularities to capture an event or activity from many different perspectives and at different levels of details. For example, in hierarchies of the events, the events may be categorized by dimensions and each category of events defined by dimensions may have different levels of granularities. Any processing of information, such as creation of the hierarchies, may be performed by the UE 101 or the online service 103 or any other service available on the network, or any combination thereof. In one embodiment, when organized by the granularities, some events will be considered as child events belonging to another event, depending on the level of the granularities and further on the values in one or more dimensions.

In another embodiment, the UE 101 can associate one or more of the defined events with content objects related to or representative of the corresponding events. By way of example, the content objects may be media data including pictures, video, audio, text and etc., and may be acquired by the sensor 111, the online service 103 or any other sources available to the UE 101. In certain embodiments, the content objects linked with the events describe the events in at least one of the dimensions. Then, the UE 101 creates a journal entry showing the events, wherein the events are described at least by the content objects linked to the events, at one level of granularity. Alternatively or in addition, the journal entry may also be created on the network side. An event at this one level of granularity in a hierarchy included in the journal entry may be selected to show another level of granularity (e.g., child events of the event shown on the journal entry). In addition, the UE 101 may select the events to be shown on the journal entry based on the number of child events of those events and the amount of content data associated with those events.

In one embodiment, the UE 101 may determine which dimension is a dominant dimension for the events, among multiple dimensions within a single event. Then, the dominant dimension is emphasized in the corresponding event, and the content data is based on the dominant dimension. The dominant dimension of the event may be determined according to the content or the title of the event. The dimensions other than the dominant dimensions may be considered as hidden dimensions. The dominant dimension as well as the hidden dimensions may be used to link the event with another event, according to the dimensions of the events.

Therefore, an advantage of this approach is that, by organizing and classifying the events and linking the events with the content object, a journal can be automatically created to describe the events. Because this process involves little or no involvement of a user, the journal can be created with little to no burden on the user. By organizing the events based on the dimensions and the granularities, different levels of details and the related content objects may be displayed in the journal entry. Further, use of the content objects such as media data allows a viewer of the journal entry to understand the content of the journal intuitively. Therefore, means for automatically generating a journal based on collected data is anticipated.

As shown in FIG. 1, the system 100 comprises a user equipment (UE) 101 having connectivity to the online service 103 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Bluetooth® Low-Energy, Zigbee, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, Personal Digital Assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.). The UE 101 can also include a single or a set of sensor nodes. Further, the UE 101 and/or related devices may be implemented in a distributed fashion. For example, the UE 101 may be distributed into several interdependent elements, e.g., a display in a monitor, a wireless communication module in a pen, the rest of the elements in a watch. By way of example, the UE 101 and the online services 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

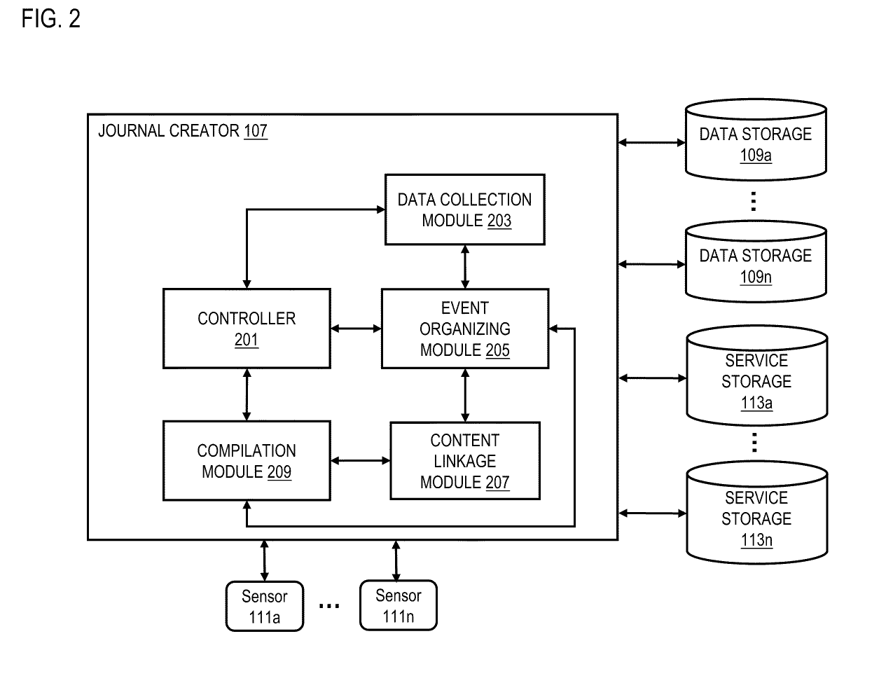

FIG. 2 is a diagram of the components of the journal creator 107, according to one embodiment. By way of example, the journal creator 107 includes one or more components for providing an actionable electronic journal. It is contemplated that the functions of these components may be combined in one or more components or performed by other components of equivalent functionality. In this embodiment, the journal creator 107 includes a controller 201, a data collection module 203, an event organizing module 205, a content linkage module 207 and a compilation module 209. The controller 201 oversees tasks, including tasks performed by the data collection module 203, the event organizing module 205, the content linkage module 207 and the compilation module 209. The event organizing module 205 analyzes the context data collected via the data collection module 203, and recognizes and organizes the events from the context data. In more detail, the event organizing module 205 classifies the context data according to dimensions and granularities, and recognizes the events in the context data based on the classification. The event organizing module 205 then creates hierarchies of the recognized events based on the dimensions and the granularities.

The content linkage module 207 selects content objects to associate with the recognized events. The content objects may be extracted from the context data or may be retrieved from the sensor 111, or a data storage 109 or a service storage 113 (e.g., via the Internet or any other network sources). In one embodiment, the content linkage module 207 determines a dominant dimension for a recognized event. Then, the content linkage module 207 places an emphasis on the dominant dimension for the corresponding event and selects the content data based on the dominant dimension. For example, if the dimensions include time, location, people and activity, the content linkage module 207 may selects one of these dimensions as a dominant dimension. Thus, if the content linkage module 207 selects time as a dominant dimension, the content linkage module 207 selects the content object within the time frame of the events. The selection of the dominant dimension for the event may be based on the content of the event.

The compilation module 209 creates entries for a journal and compiles the entries into a complete journal. In more detail, the compilation module 209 determines events of significance. An event is the event of significance if the event has enough child events in the hierarchy and/or if the child events of the event have enough content objects. Thus, the compilation module 209 determines the events of significance based on the number of the child events that the events have and/or the amount of content objects associated with the child events. The compilation module 209 creates a journal entry based on this determination. The journal entry may be a page including sections corresponding to the dimensions. Further, child events may be presented according to these sections and/or their respective dominant dimensions. The compilation module 209 compiles these journal entries to complete a journal, and these entries can be presented on a display device.

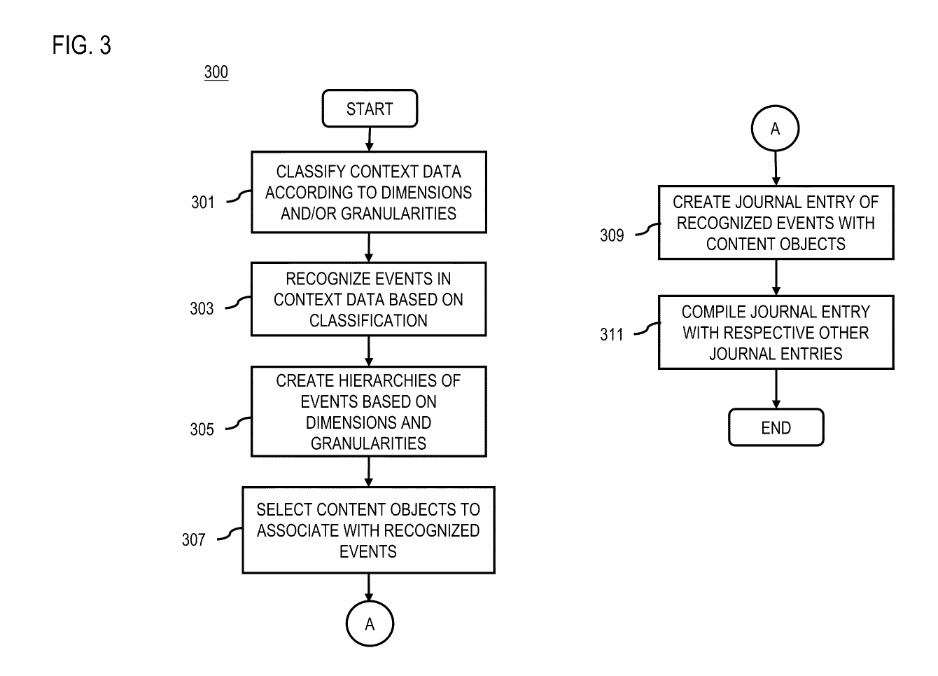

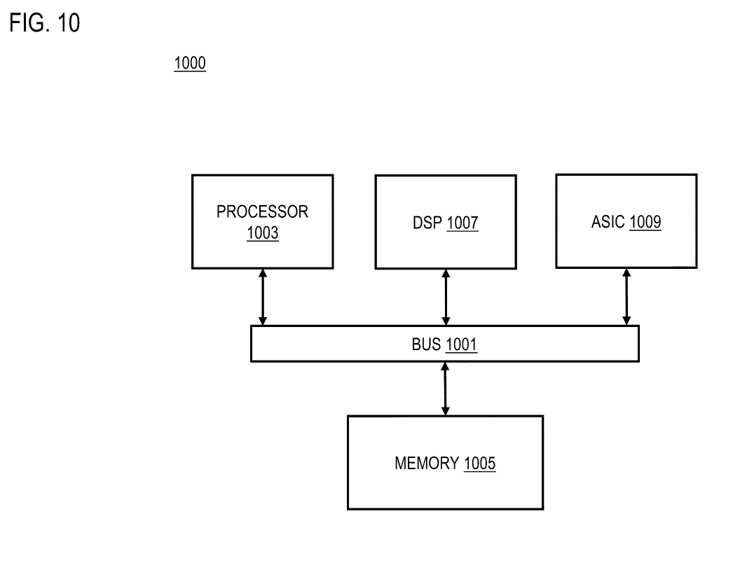

FIG. 3 is a flowchart of a process for providing an actionable electronic journal, according to one embodiment. In one embodiment, the journal creator 107 performs the process 300 and is implemented in, for instance, a chip set including a processor and a memory as shown FIG. 10. As an alternative or in addition to the journal creator 107, the process 300 may also be performed by the online service 103 or any other service available on the network. In step 301, the journal creator 107 classifies the context data according to the dimensions and/or the granularities. The journal creator 107 may apply a set of classifiers to the context data. Classifiers corresponding to the dimensions may be applied so that applying the classifiers would classify the context data by the dimensions. The dimensions may include parameters to describe an event, such as time, location, people and activity (or the “four W's” known as “When,” “Where,” “Who” and “What”). For example, a time classifier may break a continuous time into multiple time blocks, a location classifier may utilize data from the GPS device, a GSM, a Wi-Fi, a Point of Interest databases and maps, a people classifier may utilize data from the user's contacts, communication history and user profiles, and an activity classifier may utilize data from accelerometers, sound sensors and the GPS device. The dimensions may further include parameters such as “Why” and “How.” Furthermore, certain parameters of the journal creation process may be selected by the user or preference ratings may be assigned to the parameters, thereby giving more emphasis to certain parameters (e.g., emphasizing the people dimension more than the location dimension). These dimensions may be pre-determined or pre-selected dimensions, or may also be user-defined dimensions that can be customized or selected by the user. For example, a user may define a dimension that includes both time and location by mixing the two pre-determined dimensions “When” and “Where.”

Classifiers may be also applied to categorize the events to different levels of granularities. The levels of granularities (i.e., how fine or coarse the granularities are) may be defined by the level of details for the event. By way of an example, in a time dimension, a “quarter hour” may be considered to be at the finest granularity level, whereas the next two higher levels of granularities may include time units of “hour” and “12 hours,” respectively. The levels for the time dimension may further be defined by “day,” “week,” and “month.” By way of another example, in the location dimension, a point of interest (POI) pinpointing a specific location such as a museum or a restaurant may be at the finest granularity level, whereas the next level may include coarser granularities, such as “district,” “city,” “county,” “state or province,” “country,” “continent” and etc.

Further, the context data utilized in the process 300 may include data from devices and sensors, online activity data from online services, and other contexts from various sources. The devices from which the context data may be collected include mobile phones, portable media players, personal computers, car computers, digital cameras, voice recorders, televisions, digital appliances, and standalone sensors, or other users' devices that are capable of sharing their sensor/context readings and/or event classification results, etc. The sensors used to collect the context data may include accelerometers, magnetometers, gyroscopes, thermometers, barometers, GPS, GSM, Wi-Fi, Bluetooth, and etc. The context data may also include readings from “soft” sensors such as profile settings, schedules, foreground/background processes, battery levels, charging states, memory and storage states, idle times, keystrokes, mouse moves, messages, calendar entries, browsing history, communication history, and higher level context information such as “on a meeting”, “at home”, working”, “driving”, etc. The online activities may include social networking service activities such as status updates, friends' status updates and comments on activities as well as content uploads and downloads, online alerts and etc. Other context data may include weather, news, popular events, stock quotes, sports scores, music rankings, etc. The context data may be collected and sent to a storage medium, so that they can be retrieved later to be processed. The storage medium may be a storage medium local to the UE 101, such as the data storage 109, or may be a central repository such as a server storage. The server storage may be the service storage 113 of the online service 103.

In step 303, the journal creator 107 recognizes events in the context data based on the classification of the context data performed in step 301. In other words, the journal creator 107 recognizes and extracts events based on the classification according to the dimensions and/or granularities. For example, in order to recognize events at different granularities in the time dimension, the events that happened at different time periods are recognized, wherein the time periods may be in different lengths, depending on the granularities. As another example, for the events in the location dimension, the events that happened at different locations at different granularities may be recognized. When the events including different dimensions are recognized, multiple dimensions may represent a single event. Thus, in one embodiment, the journal creator 107 may determine a dominant dimension for each event, and recognizes the event as the event of the dominant dimension. The journal creator 107 may determine a dominant dimension among multiple dimensions for the event based on the content of the event. For example, if the content of the event is mainly about a visit to the Union Square in San Francisco, the dominant dimension may be the location dimension. As another example, if the content of the event is mainly about meeting with friends, the dominant dimension may be the people dimension.

Then, the journal creator 107 creates hierarchies of events based on the dimensions and the granularities, as shown in step 305. Because events are recognized based on the classification according to the dimensions and the granularities, the events may be organized based on the dimensions and the granularities as well. One event may have different hierarchies of events, depending on the dimensions. For example, an event of a vacation may include four different hierarchies of events including “visit to San Francisco” (location), a “weekend getaway” (time), a “college friends gathering” (people), and a “dancing lesson” (activity). As explained above, if the event has multiple dimensions, the dimension representing the event may be a dominant dimension, whereas other dimensions in the event may be hidden. Under each dimension, the events may be organized in hierarchies according to the granularities. In one embodiment, the highest level of the hierarchy within each dimension may include an event with the coarsest granularity, and as the level of the hierarchy goes down, the event with finer granularities are included. Further, in this example, the hierarchy including the event “a weekend getaway,” may have different levels of hierarchy depending on the granularities in time, such as “weekend,” “days,” and “hours.” Then, according to the granularities, the event for the weekend will be at the highest level of the hierarchy, and the event for each day will be at the second highest level, and the event for each hour will be at the lowest level.

In step 307, the journal creator 107 selects content objects to associate with the recognized events. The content objects may include media data such as pictures, images, videos, sounds, texts and etc. Further, this selection of content objects may be based on the dominant dimension. Thus, if the event's dominant dimension is the time dimension, the content object may be selected within the time frame of the event's time. If the event's dominant dimension is the location dimension, the content object that includes the location of the event may be selected. Further, for the event with the people dimension as a dominant dimension, the content object including faces or voices of the people of the event may be selected. For the event with the activity dimension as the dominant dimension, the content object reflecting the activity may be selected. The content objects may include multimedia objects corresponding to their respective events. The multimedia objects may be reproduced upon selection.

In step 309, the journal creator 107 creates the journal entry of the recognized events with the content objects. The content objects representing the respective events may be placed together in a journal entry. Thus, the journal entry may include a collage of content objects corresponding to the events. In one embodiment, the journal entry page is created by displaying content objects from the highest level of hierarchy in granularities. Then, the content object in the highest level of hierarchy can be selected to access the content objects for the lower levels of the hierarchy for the corresponding event. Further, the content objects on the journal entry may be organized by dimensions. For example, the journal entry may be divided into sections, wherein the sections represent corresponding dimensions. Then, a root event (an event at the highest level of hierarchy in granularities) will be associated with one of the sections, depending on its dimension or its dominant dimension. Then, the section may have a collage of content objects for respective child events (events at a lower level of hierarchy in granularities) for the root event of the section. In this case, the root event is considered a parent event (events at a higher level) of the child events. Then, the journal creator 107 compiles the journal entry with respective other journal entries, as shown in step 311, thus forming a compilation of journals. The journal entries may be organized by time, event, category, and etc. Further, an index of the journal entries may be created with page numbers and brief titles for the journal entries.

This process is advantageous in that it provides a user of the UE 101 a way to automatically create a journal of the past events using content objects describing the past events at different hierarchies. Thus, this process reduces or eliminates a burden on a user by providing an easy way to keep a journal of the past events, and also enhances journal viewing experience by providing a convenient way to view the past events by creating a journal with content objects organized by hierarchies. Further, this process may enable targeted advertisements or recommendation for the user based on the contents of the journal. The journal creator 107 is a means for achieving these advantages.

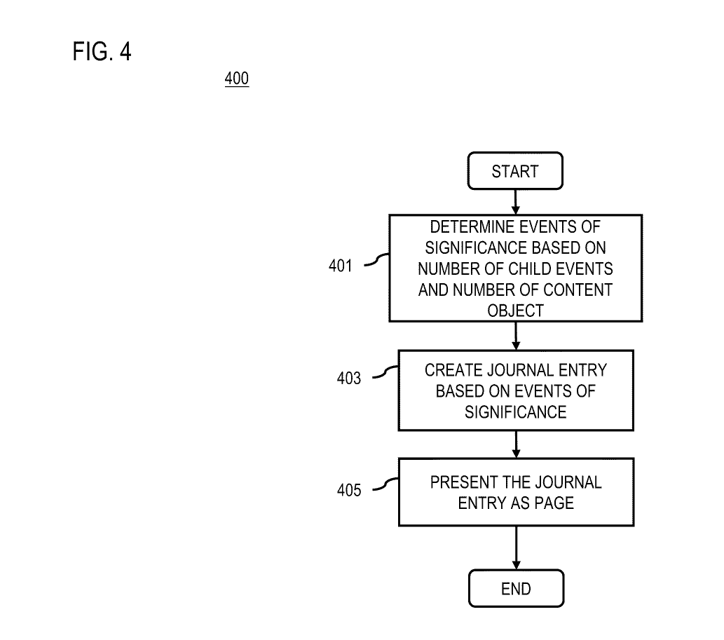

FIG. 4 is a flowchart of a process for presenting events on a journal entry, according to one embodiment. In one embodiment, the journal creator 107 performs the process 400 and is implemented in, for instance, a chip set including a processor and a memory as shown FIG. 10. As an alternative or in addition to the journal creator 107, the process 400 may also be performed by the online service 103 or any other service available on the network. This process may take place while creating the journal entry of the recognized events with content objects, as shown in step 309 of FIG. 3. As discussed above, when the events for each dimension are organized in hierarchies, the event in the highest level of the hierarchy in granularities may be considered a root event. Further, the event in a higher level of the hierarchy in granularities may be considered a parent event for the events in the lower levels of the hierarchy under the parent event, as the events in the lower levels are considered child events. In step 401, the journal creator 107 determines the events of significance based on the number of their child events and/or the number of content objects under the events. Thus, if a parent event has a large number of child events, and the child events have a large number of content objects, then the parent event may be considered an event of significance (i.e., the parent event is rich enough to be selected as an event to be presented on the journal entry, whereas other events that are not as rich may not be selected for the journal entry). Next, in step 403, the journal creator 107 creates a journal entry based on the event or events of significance. The journal entry may include content objects representing child events of the parent event, wherein the parent event is the event of significance. Then, in step 405, the journal entry is presented as a page of a journal. The page may display content objects corresponding to the child events of the parent event. The child events may be selected to reproduce or play the content objects.

This process is advantageous in that it provides a user of the UE 101 a way to effectively select events of significance when there are too many events to be presented on a journal entry. The journal creator 107 is a means for achieving this advantage.

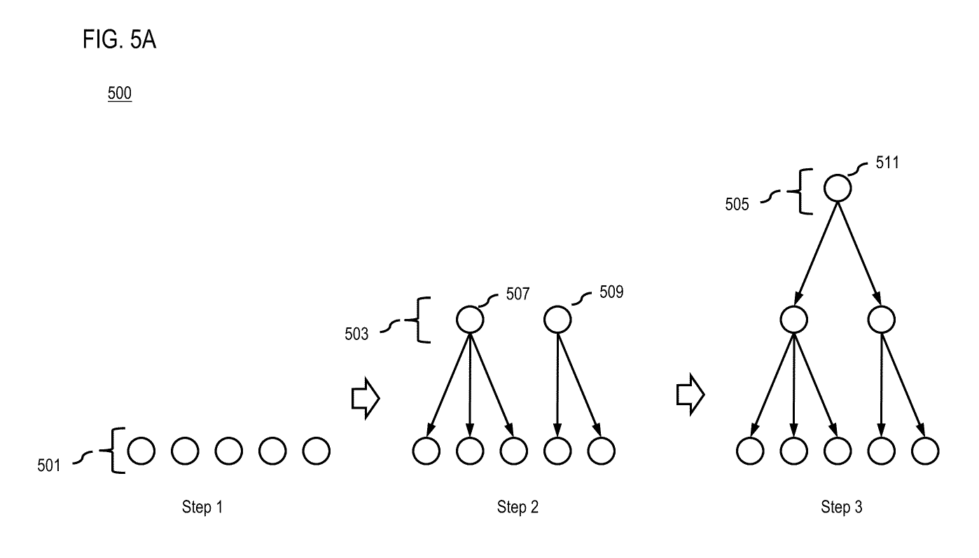

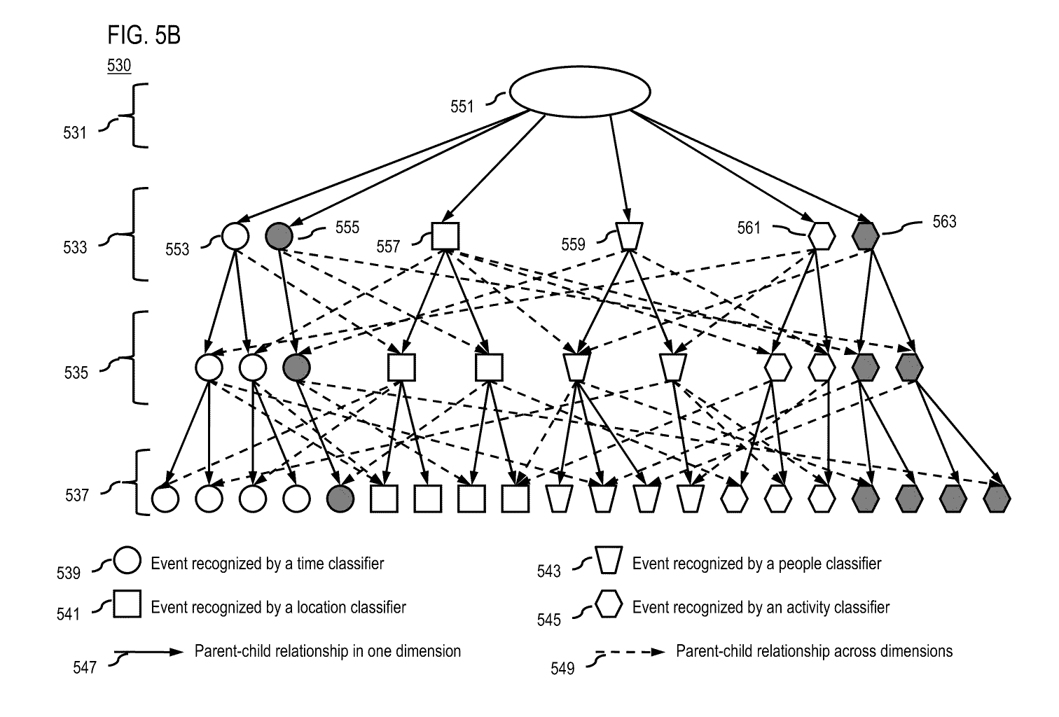

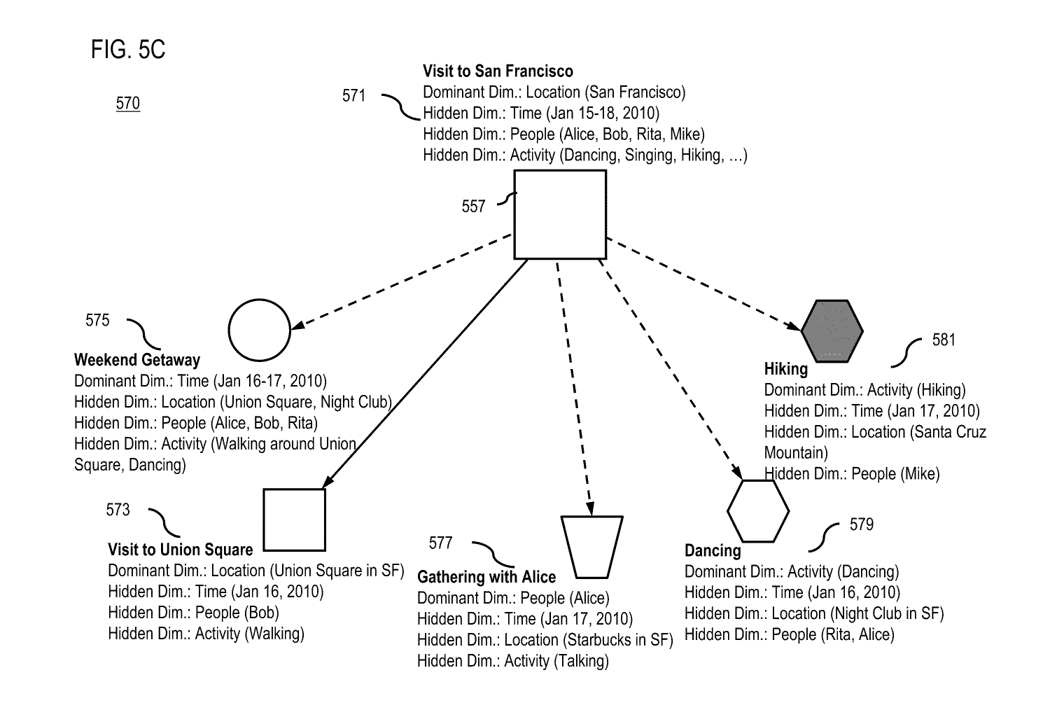

FIGS. 5A-5C are example diagrams of hierarchies utilized in the processes of FIG. 3 such as steps 301, 303 and 305, according to one embodiment. FIG. 5A shows that for each dimension, the journal creator 107 uses classifiers to recognize events at the most detailed level (finest granularity) and then move up the level to recognize events at less detailed levels (coarsest granularity) of granularities. In step 1, the events at the most detailed level (at the bottom level) 501 are recognized. Then, in step 2, the events at the second most detailed level (at the middle level) 503 are recognized. Lastly, in step 3, the events at the least detailed level (at the top level) 505 are recognized. The events at different levels of granularities may be associated with one another, depending on the nature of the events. In this example, the left three events and the right two events at the most detailed level 501 are associated with an event on the left side 507 and an event on the right side 509 at the second most detailed level, respectively. The event on the left side 507 and the event on the right side 509 are associated with the event at the least detailed level 511. Thus, FIG. 5A shows creating a hierarchy of granularities for a corresponding dimension using a bottom-up approach, wherein the journal creator 107 recognizes the events at the bottom level (the most detailed level) first and then moves up the level to recognize the events at the upper level (less detailed level). As an alternative approach or in addition to this approach, a top-down approach may be used to have the classifiers recognize events at the top level first and then recognize the events at the lower levels.

FIG. 5B shows the hierarchies of the events for various dimensions and granularities, according to one embodiment. As shown in FIG. 5B, the event 530 has four different granularity levels in the hierarchies, 531, 533, 535 and 537, wherein the top granularity level 531 is the least detailed level (the broadest level). The event 530 includes events in four dimensions for the hierarchies, the time dimension 539, the location dimension 541, the people dimension 543 and the activity dimension 545. These events at different granularity levels may be linked with one another, to show a parent-child relationship. The root event 551 from the top granularity level 531 in this example moves down to the second granularity level 533, by branching into two events in the time dimension, 553 and 555, an event in the location dimension 557, an event in the people dimension 559, and two events in the activity dimension 561 and 563. These events in the second granularity level 533 further branches out to their child events in the third granularity level 535 and the fourth granularity level 537. In order to show the relationship between the events at these four granularity levels 531, 533, 535 and 537, FIG. 5B shows a solid arrow 547 for a parent-child relationship in one dimension (the same dimension) and a dotted arrow 549 for the parent-child relationship across different dimensions. As for the parent-child relationship across different dimensions, their child events may be related to parent events of different dimensions if the dimensions of the events are represented by their respective dominant dimensions and the hidden dimension of one event is related to the dominant dimension of another event. This relationship is described more in detail in the example shown in FIG. 5C.

FIG. 5C shows more details on cross linking to illustrate a parent-child relationship. In FIG. 5C, the event in the location dimension 557 from the second granularity level 533 of FIG. 5B is used as an example for the parent event 571. The parent event 571 has a location dimension (San Francisco) as a dominant dimension, which represents “Visit to San Francisco.” The parent event 571 also has other hidden dimensions, including the time dimension (Jan. 15-18, 2010), the people dimension (Alice, Bob, Mike, . . . ), and activity dimension (Dancing, Singing, Hiking, . . . ). The parent event 571 is linked with the child events 573, 575, 577, 579 and 581 in third granularity level 535 of FIG. 5B. Among the child events, the “Visit to Union Square” event 573 is within the same dimension as the parent event 571, as its dominant dimension is the location dimension, and thus the arrow between the parent event 571 and the “Visit to Union Square” event 573 is a solid arrow showing a parent-child relationship within the same dimension. Further, the “Visit to Union Square” event 573 is a child event, it is in a more detailed level and shows a more detailed location (i.e., Union Square in San Francisco) than the broader location (i.e., San Francisco) shown in the parent event 571. The Visit to Union Square” event 573 also has other hidden dimensions, such as the time dimension (Jan. 16, 2010), the people dimension (Bob) and the activity dimension (Walking) The “Weekend Getaway” event 575 has the time dimension as a dominant dimension. The time range (Jan. 16-17, 2010) for the “Weekend Getaway” event 575 falls within the time range (Jan. 15-18, 2010) for the parent event 571, and the “Weekend Getaway” event 575 may be linked with the parent event 571. Because the parent event 571 and the Weekend Getaway” event 575 have different dominant dimensions, they are linked by a dotted arrow. Further, the time for the “Weekend Getaway” event 575 is in a more detailed time range than the time for the parent event 571. The “Gathering with Alice” event 577 has a people dimension (Alice) as a dominant dimension, which is within the people dimension (Alice, Bob, Rita, Mike) of the parent event 571. Further, the “Dancing” event 579 has an activity dimension (Dancing) and the “Hiking” event 581 has an activity dimension (Hiking) as a dominant dimension, which are within the activity dimension (Dancing, Singing, Hiking, . . . ) of the parent event 571. Hence, the “Gathering with Alice” event 577, the “Dancing” event 579, and the “Hiking” event 581 can also be linked with the parent event 571 with dotted arrows because their dominant dimensions that are different from the dominant dimension of the parent event 571 fall within the dimensions of the parent event 571. Further, the hidden dimensions of the “Gathering with Alice” event 577, the “Dancing” event 579, and the “Hiking” event 581 also fall within the respective dimensions of the parent event 571.

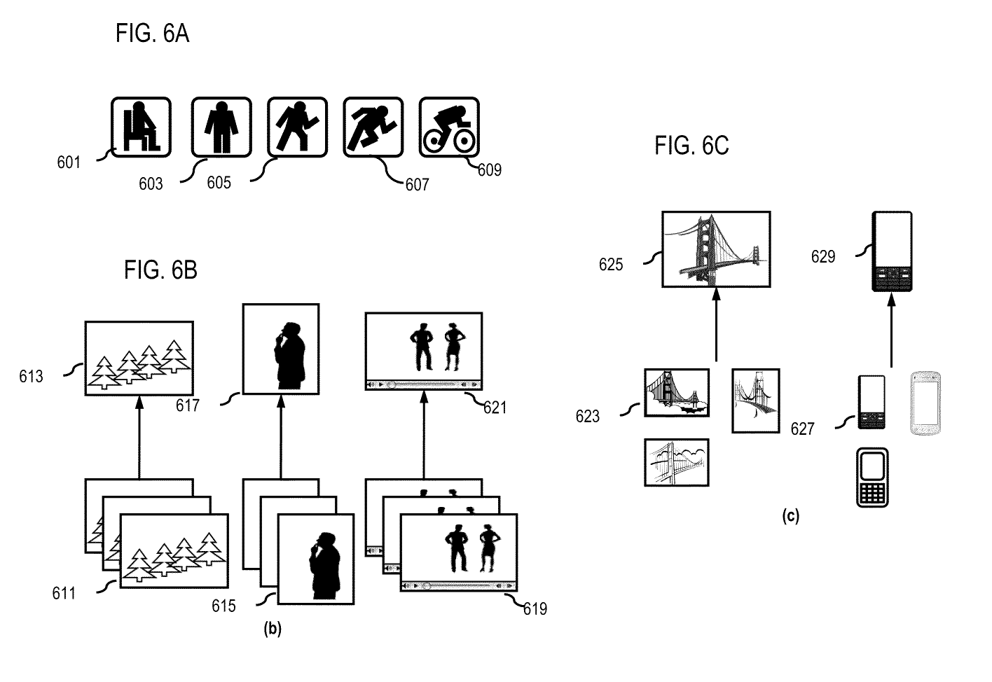

FIGS. 6A-6C are example diagrams of content objects for a journal entry utilized in the processes of FIG. 3, according to various embodiments. FIG. 6A shows examples of icons that may be used to represent an event. The icons 601, 603, 605, 607 and 609 represent sitting, standing, walking, running and bicycling, respectively. An event may be associated with one of these icons, and the associated icon may be displayed on the journal entry. FIG. 6B shows selecting a representative content object from a group of similar content objects generated by a user, such that the representative content object may be associated with a corresponding event. Among a group of scenery pictures 611 generated by the user, the representative scenery picture 613 may be selected. Also, among a group of portrait pictures 615 taken by the user, the representative portrait picture 617 may be selected. Further, among a group of videos 619 taken by the user, the representative video 621 may be selected. The selection of the representative among a group of content objects may be performed by a user or automatically by the journal creator 107 that selects the content object that matches the best with the corresponding event. FIG. 6C shows that a representative content object may also be selected from an external source (i.e., not generated by the user), such as an Internet or a storage medium. A group of images 623 shows a group of images of the Golden Gate Bridge available on the Internet, and a representative image 625 is the selected representative image, which may be associated with an event such as “Visiting the Golden Gate Bridge.” As another example, another representative image 629 can be selected from another group of cellular phone images 627 to be associated with an event such as “Calling on the cellular phone.”

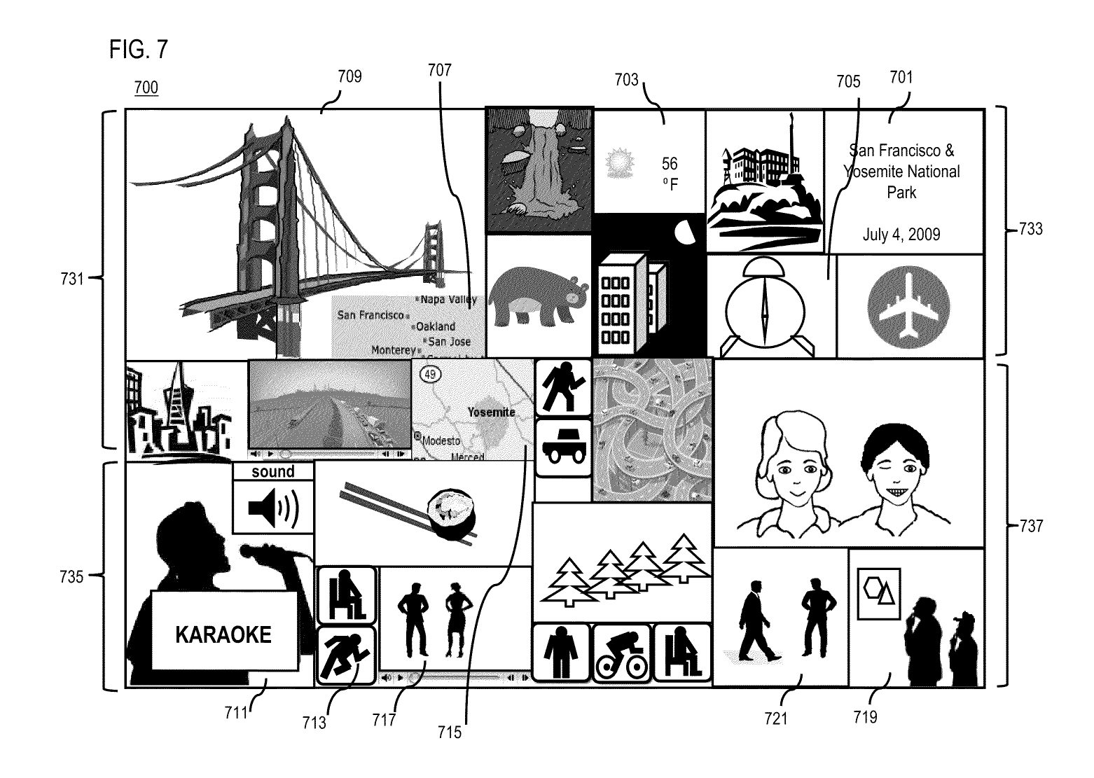

FIG. 7 is an example journal entry created by the processes of FIG. 3, according to one embodiment. The title section 701 shows that this page is about San Francisco & Yosemite National Park for Jul. 4, 2009. Also, the event with a dominant time dimension 703 shows that the weather was sunny and 56 degrees, and the event with the dominant time dimension 705 shows that the user woke up at 6:00 AM. The event with dominant location dimensions 707 and 715 show that these events took place in Yosemite and San Francisco by showing maps of Yosemite National Park and San Francisco, respectively. The event with a dominant location dimension 709 shows a picture of the Golden Gate Bridge to represent visiting the Golden Gate Bridge. The event with a dominant activity dimension 711 shows that the user went to Karaoke, and provides an option to play a sound associated with this event. Another event with a dominant activity dimension 713 shows that the user was running by showing an icon that represents running Also, another event with a dominant activity dimension 717 shows that the user was socializing, and provides an option to play a video associated with this event. Further, the event with a people dimension 719 shows that the user went to an art gallery with a friend, and another event with a people dimension 721 shows that the user met with another friend on a street. In this example, the journal entry is divided into four quadrants, a location quadrant 731 (top left), a time quadrant 733 (top right), an activity quadrant 735 (bottom left) and a people quadrant 737 (bottom right). Each quadrant contains events having a dominant dimension corresponding the quadrant.

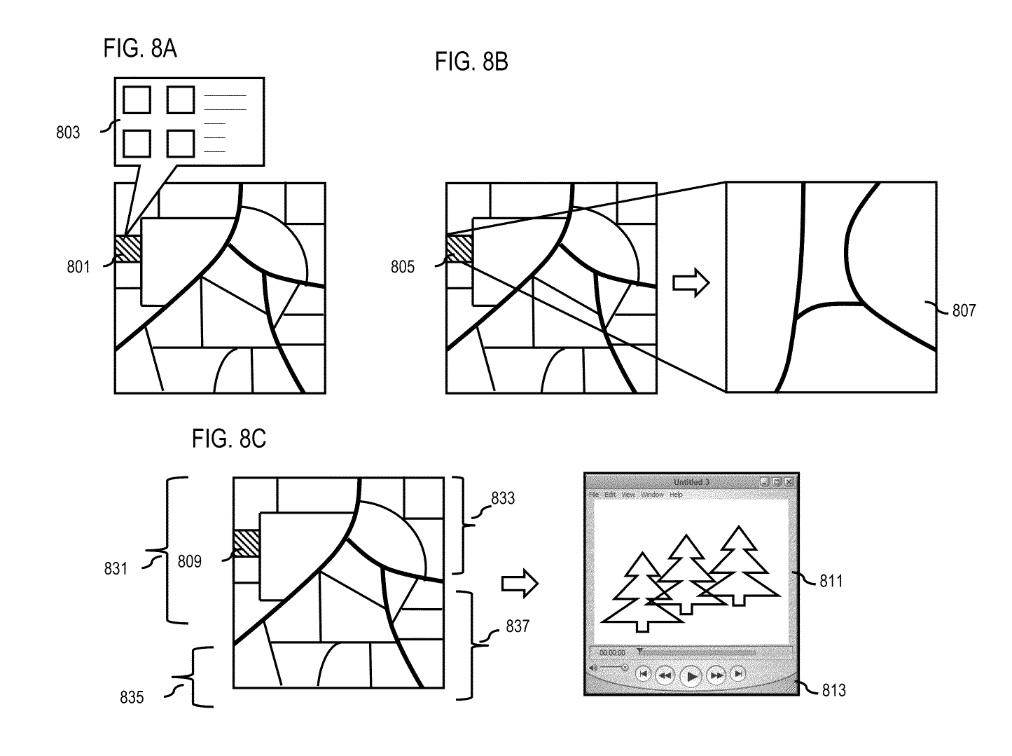

FIGS. 8A-8C are diagrams of the journal entry utilized in the processes of FIG. 3, according to one embodiment. FIG. 8A shows a child event 801 that is actionable and thus can be selected to show more details 803 about the child event 801, including pictures and words. FIG. 8B shows a child event 805 having its own child events 807, and thus the child event 805 is expanded to show its own child events 807 upon selection. In FIG. 8C, the child event 809 has a media content 811 that can be played by a media player or viewer 813. In this example, as similarly shown in FIG. 7, the journal entry is divided into four quadrants, a location quadrant 831, a time quadrant 833, an activity quadrant 835 and people quadrant 837. Each of these quadrants may represent a root event, which is a parent event for the child events within the corresponding quadrant. For example, the location quadrant 831 may correspond to a parent event “visit to San Francisco”, and may include child events such as “visit to the Union Square” and “visit to the Golden Gate Bridge.” As another example, the time quadrant 833 may correspond to a parent event “a month of January,” having child events such as “weekend getaway.” The reproduction or details 803, 807 and 811 of the child events 801, 805 and 809 may be displayed on a full screen upon selection or on a portion of the screen. Further, the user may navigate from the reproduction or details of the child events back to the main journal entry by pressing a button such as a “back” button.

This is only one example for the representation of the electronic journal. Other templates and layouts can be used to render visually the content. In fact, this can be provided by third parties and it can be implemented by various business models. Here is one example: via a mobile device we have the user's data (sensor, contextual, etc.) as described above. This data is provided to a hybrid service which exists in a distributed fashion on both the device and on the network side. Once the journal is edited and available to present, there can be several options. One is to use the default rendering template provided by the device manufacturer or the network based service provider. However, it is also possible that a third party provides other choices for templates, such as artistic templates having humorous, art-deco, modern, classic, oriental, etc. types of visual rendering. For example, a third party may send a blank postcard to the user and this blank postcard may be used as a template that is then filled up by the content that belongs to the user, either raw sensor/context info or classified representative events. In any case, this “postcard” which is a type of the electronic journal entry with the information can then be distributed to others (e.g., to friends or within a social network). It is also possible, that each receiver has his/her own preferred visual rendering. For example, user A has art-deco type of postcard template, while user B has classic one as the preferred visual rendering. The business model can work so that whenever a postcard template is used for presenting the journal, a micro payment can be made for the third party. Furthermore, it can be implemented so that the delivery mechanism has various forms including: 1) the electronic journal is delivered physically to the receiving device in a form of a multimedia message, or 2) only the template is delivered and all the content elements are fetchable from the web, and 3) both the template and the content are available on the web and when the viewer views the template and the content, the viewer views the journal as if the viewer is browsing the journal over internet. What comes to the actionable events, i.e., the content in the journal: some or all events can be expanded, thereby opening up a new more detailed view for that given dimension. Eventually opening to the highest granularity, the user may be able to see a movie-like presentation of the events. Furthermore, each actionable event in the journal, can have a small icon in one of its corner indicating that it is available to access additional information, such as detailed info on the event, metadata or even a contextually relevant advertisement. A device manufacturer or a service provider could be the broker and sell these places. It is non-intrusive as the viewer explicitly needs to turn the tile representing the event to see the additional information (like a white paper page you turn to see what is on the other side). Anyone who sends out an electronic journal to a friend can opt-in to have ads on the other side of the journal and anyone receiving electronic journals can opt-in to have or receive ads on the back side of the building elements of the electronic journal. The ads may be related to the electronic journal or a portion of the electronic journal, or the ads may be any type of advertisements including those unrelated to the electronic journal. Bonuses and credits can be counted in such a way that if a user signs up for a journal. , then every time someone views a journal element the user can earn bonuses and credits. Further, if the viewer clicks on the advertisement, additional bonuses and/or credits can be earned.

The processes described herein for providing an actionable electronic journal may be advantageously implemented via software, hardware, firmware or a combination of software and/or firmware and/or hardware. For example, the processes described herein, including for providing user interface navigation information associated with the availability of services, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

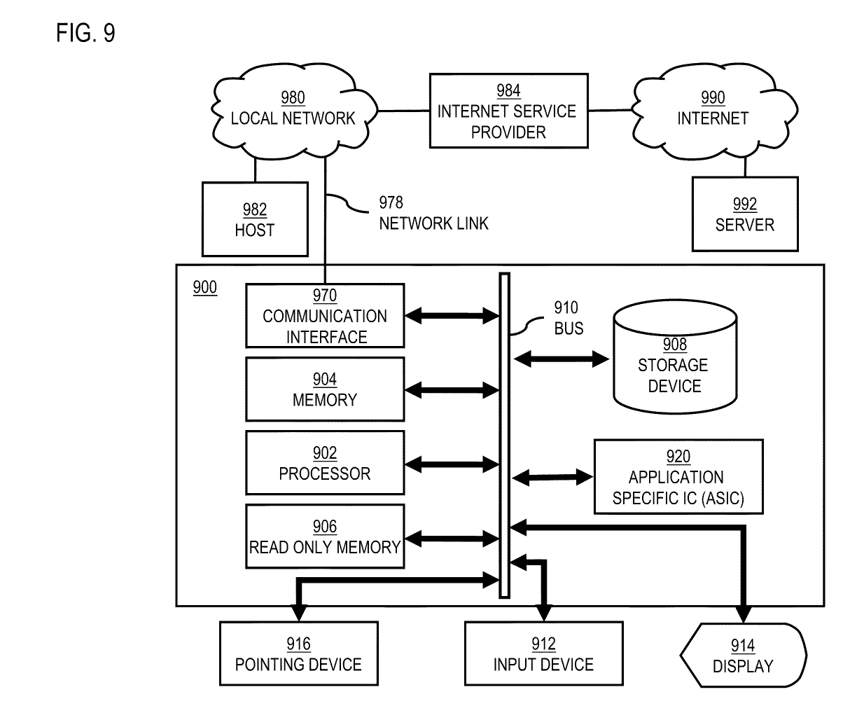

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to provide an electronic journal as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of providing an actionable electronic journal.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to provide an electronic journal. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or other dynamic storage device, stores information including processor instructions for providing an actionable electronic journal. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for providing an actionable electronic journal, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914, or can be novel type. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for providing an actionable electronic journal.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to provide an electronic journal as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of services. Chip set or chip 1000, or a portion thereof, constitutes a means for performing one or more steps of providing an actionable electronic journal.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to providing an actionable electronic journal. The memory 1005 also stores the data associated with or generated by the execution of the inventive steps.

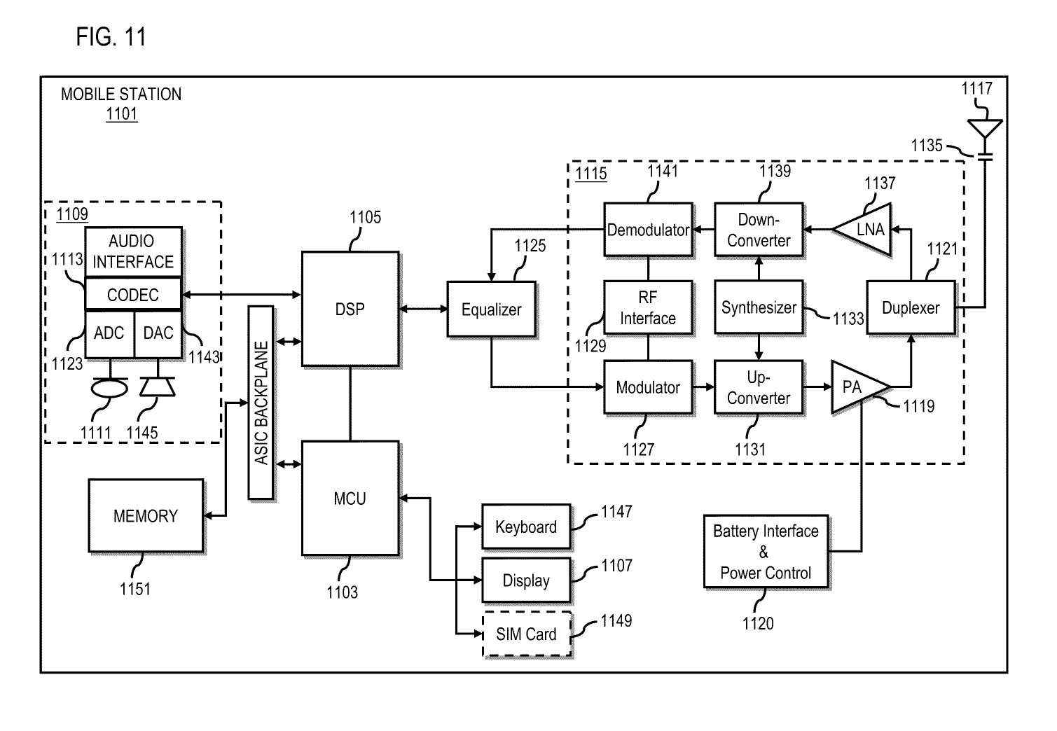

FIG. 11 is a diagram of exemplary components of a mobile terminal (e.g., handset) for communications, which is capable of operating in the system of FIG. 1, according to one embodiment. In some embodiments, mobile terminal 1100, or a portion thereof, constitutes a means for performing one or more steps of providing an actionable electronic journal. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of providing an actionable electronic journal. The display 11 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to provide an electronic journal. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
classifying context data associated with a user according to a plurality of dimensions, granularities, or a combination thereof;
recognizing one or more events in the context data based, at least in part, on the classification; and
creating one or more hierarchies of the recognized events based, at least in part, on the dimensions and the granularities.

2. A method of claim 1, further comprising:
determining a number of child events of at least one of the recognized events and an amount of content data associated with the child events; and
causing, at least in part, creation of a journal entry for the at least one of the recognized events based on the determination.

3. A method of claim 2, further comprising:
causing, at least in part, presentation of the journal entry as a page, wherein the page includes sections corresponding to one or more of the dimensions; and
causing, at least in part, presentation of the child events according to the sections.

4. A method of claim 1, further comprising:
selecting one or more content objects to associate with at least one of the recognized events,
wherein the content objects represents the at least one of the recognized events in the journal entry.

5. A method of claim 4, further comprising:
determining a dominant dimension to represent at least one of the recognized events,
wherein the dominant dimension is emphasized in the at least one of the recognized events, and wherein the selection of the content data is based, at least in part, on the dominant dimension.

6. A method of claim 1, further comprising:
compiling the journal entry for the at least one of the recognized events with respective other journal entries for one or more other recognized events.

7. A method of claim 1, wherein the plurality of dimensions includes time, location, people, activity and one or more user-defined dimensions.

8. A method of claim 1, wherein the contextual data includes sensor data, data on online activities, context services, or a combination thereof.

9. A method of claim 2, wherein the journal entry is created using a predefined template, the predefined template being provided by a device manufacturer, a service provider, a third party, a developer community, or a combination thereof.

10. A method of claim 2, wherein the at least one recognized event is associated with additional metadata, or further details about the event, or advertisements, or a combination thereof.

11. An apparatus comprising:
at least one processor; and
at least one memory including computer program code for one or more programs,
the at least one memory and the computer program code configured to, with the at least one processor, cause the apparatus to perform at least the following,
classify context data associated with a user according to a plurality of dimensions, granularities, or a combination thereof;
recognize one or more events in the context data based, at least in part, on the classification; and
create one or more hierarchies of the recognized events based, at least in part, on the dimensions and the granularities.

12. An apparatus of claim 11, wherein the apparatus is further caused to:
determine a number of child events of at least one of the recognized events and an amount of content data associated with the child events; and
cause, at least in part, creation of a journal entry for the at least one of the recognized events based on the determination.

13. An apparatus of claim 12, wherein the apparatus is further caused to:
cause, at least in part, presentation of the journal entry as a page, wherein the page includes sections corresponding to one or more of the dimensions; and
cause, at least in part, presentation of the child events according to the sections.

14. An apparatus of claim 11, wherein the apparatus is further caused to:
select one or more content objects to associate with at least one of the recognized events, wherein the content objects represents the at least one of the recognized events in the journal entry.

15. An apparatus of claim 14, wherein the apparatus is further caused to:
determine a dominant dimension to represent at least one of the recognized events,
wherein the dominant dimension is emphasized in the at least one of the recognized events, and wherein the selection of the content data is based, at least in part, on the dominant dimension.

16. An apparatus of claim 11, wherein the apparatus is further caused to:
compile the journal entry for the at least one of the recognized events with respective other journal entries for one or more other recognized events.

17. An apparatus of claim 11, wherein the plurality of dimensions includes time, location, people activity and one or more user-defined dimensions.

18. An apparatus of claim 11, wherein the contextual data includes sensor data, data on online activities, context services, or a combination thereof.

19. An apparatus of claim 12, wherein the journal entry is created using a predefined template, the predefined template being provided by a device manufacturer, a service provider, a third party, a developer community, or a combination thereof.

20. An apparatus of claim 12, wherein the at least one recognized event of the journal is associated with additional metadata, or further details about the event, or advertisements, or a combination thereof.

21-61. (canceled)
